(19) United States
(12) Patent Application Publication
(10) Pub. No.: US 2015/0368936 A1
(43) Pub. Date: Dec. 24, 2015

(54) DISTORTION FREE DOOR HANDLE

(71) Applicant: Ford Global Technologies, LLC, Dearborn, MI (US)

(72) Inventors: Laurent Bernard CHAPPUIS, Grosse Ile, MI (US); Jason Douglas SCOTT, Farmington Hills, MI (US); Kevin Taylor, Inkster, MI (US)

(21) Appl. No.: 14/313,538

(22) Filed: Jun. 24, 2014

(51) Int. Cl. E05B 85/16; B60J 5/04

(52) U.S. Cl. CPC E05B 85/16; B60J 5/0416

(57) ABSTRACT

An automotive door panel is disclosed. The automotive door panel comprises an outer panel, a bezel, a handle and in inner reinforcement. The outer panel has a depression formed on an outside surface surrounding a handle opening. The bezel seats within the depression of the door panel. The handle is mounted to the bezel and includes an attachment member in a YZ axis. The inner reinforcement member has a mounting flange oriented in the YZ axis. A fastener extends through the mounting flange in an X-direction and connects to the attachment member.

### TECHNICAL FIELD

The present disclosure relates to door handle assemblies that may be used on motor vehicles and more particularly to door handle assemblies having an attachment mechanism that does not cause localized distortion.

### BACKGROUND

Motor vehicles typically include one or more doors providing access to the interior of the vehicle. At least one door handle assembly is mounted on an interior and/or exterior surface or skin of each door to permit selective opening and closing of the door. The door handle assemblies are typically attached to an associated door utilizing suitable fasteners and tools. Depressions are formed in the door adjacent the handle location to allow a hand to grasp the handle.

However, formed door handle depressions, such as in high strength steel or aluminum materials, often cause undesirable surface distortion on the door outer skin if connected directly to the outer panel. One proposed solution to address this issue has been to place the door handle depression in a plastic bezel, which only requires a shallow depression in the door surface. However, this proposed solution requires either a floating reinforcement to be positioned behind the handle or a connection positioned between the door handle bezel and an already existing component of the door structure. To avoid the complexity of a floating reinforcement, typically, the door handle bezel is attached to an existing component. For ease of assembly, such a connection is typically done with the fasteners' axis set in the y-axis of the vehicle (i.e., cross-car). However, tying the handle depression bezel to any inner component in the y-axis direction ties the door outer surface to that inner component. Accordingly, the door outer surface is subject to the variability of the assembly process.

Indeed, the distance between the outer door panel and an inner reinforcement attached to the inner door varies due to tolerances. As a result, when attaching the outer door panel to the inner component, such tolerances get translated to surface distortion as the outer panel may be deformed to securely fix the bezel to the existing inner component. Thus the variability experienced in the assembly process still results in unacceptable surface distortions.

A door handle arrangement is needed that addresses surface distortion issues by providing a connection method not subject to assembly tolerances issues discussed above.

### SUMMARY

In one example, an automotive door panel is disclosed. The automotive door panel comprises an outer panel, a bezel, a handle and an inner reinforcement. The outer panel has a depression formed on an outside surface surrounding a handle opening. The bezel seats within the depression of the door panel. The handle is mounted to the bezel and includes an attachment member in a YZ plane so as to be generally perpendicular to an XZ plane in which an outer door panel lies. The inner reinforcement member has a mounting flange oriented in the YZ axis. A fastener extends through the mounting flange in an X-direction and connects to the attachment member.

In another example, a door handle assembly for a vehicle is disclosed. The door handle assembly comprises a bezel assembly and an inner reinforcement member. The bezel assembly receives a handle sub-assembly. The handle sub-assembly further comprises an attachment member that is oriented in a YZ plane so as to be generally perpendicular to an XZ plane in which the bezel assembly is oriented. The inner reinforcement member has a mounting flange oriented in the YZ plane. A fastener extends through the mounting flange in an X-direction and connects to the attachment member of the bezel.

In a further example, an automotive door panel is disclosed. The automotive door panel comprises an outer panel, a bezel, a handle and an inner reinforcement member. The outer panel includes a depression formed on an outside surface thereof such that the depression surrounds a handle opening. An inwardly extending wall member extends from an edge of the handle opening. At least one locating and attachment tab extends from an outer edge of the inwardly extending wall member.

The bezel seats within the depression and includes at least one fastening element that is configured to engage with the locating and attachment tab in a Y-direction with respect to the outer door panel. The handle is mounted to the bezel and includes an attachment member positioned in a YZ plane, which is generally perpendicular to an XZ plane in which the outer door panel lies. The inner reinforcement member has a mounting flange oriented in the YZ plane. The fastener extends through the mounting flange in an X-direction and connects to the attachment member.

### BRIEF DESCRIPTION OF THE DRAWINGS

FIG. 1 is a partial elevational view of a vehicle door, with a door handle assembly.

FIG. 2 is an enlarged partially exploded view of an outside panel of a vehicle door and a door handle assembly.

FIG. 3 is an enlarged assembly view of an inside surface of the outside panel of the vehicle door and the door handle assembly of FIG. 2.

FIG. 4 is a cross-sectional view of the outside panel of the vehicle door and the door handle assembly of FIG. 2, taken along lines 4-4 of FIG. 3.

FIG. 5 is an enlarged perspective view of an inner subassembly of the vehicle door.

FIG. 6 is a cross-sectional view of the vehicle door taken along lines 6-6 of FIG. 1, illustrating a latch reinforcement attachment.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

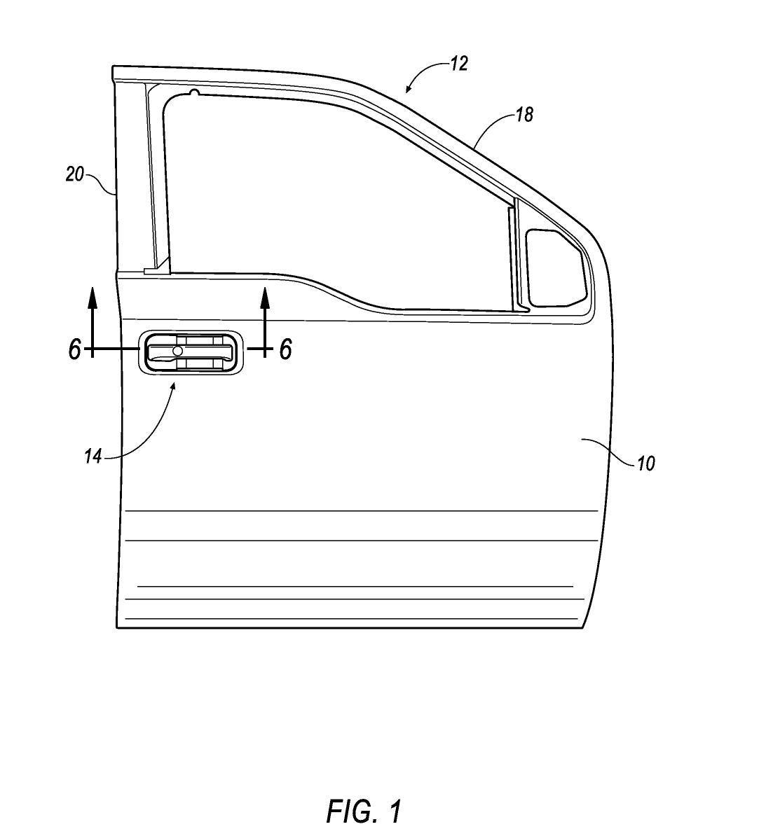

Referring to FIG. 1, a partial view of a door 10 for a vehicle 12 is illustrated with an exemplary door handle assembly 14. In one arrangement, the door 10 may be positioned in a door opening defined by a front quarter panel (not shown), positioned to the right of the door 10, an A pillar 18, a B pillar 20, and a sill (not shown), positioned along the bottom of the door 10. The door 10 may be made of any suitable material. However, use of aluminum is one example of desired material, due to the reduced weight over other materials, while still exhibiting necessary strength.

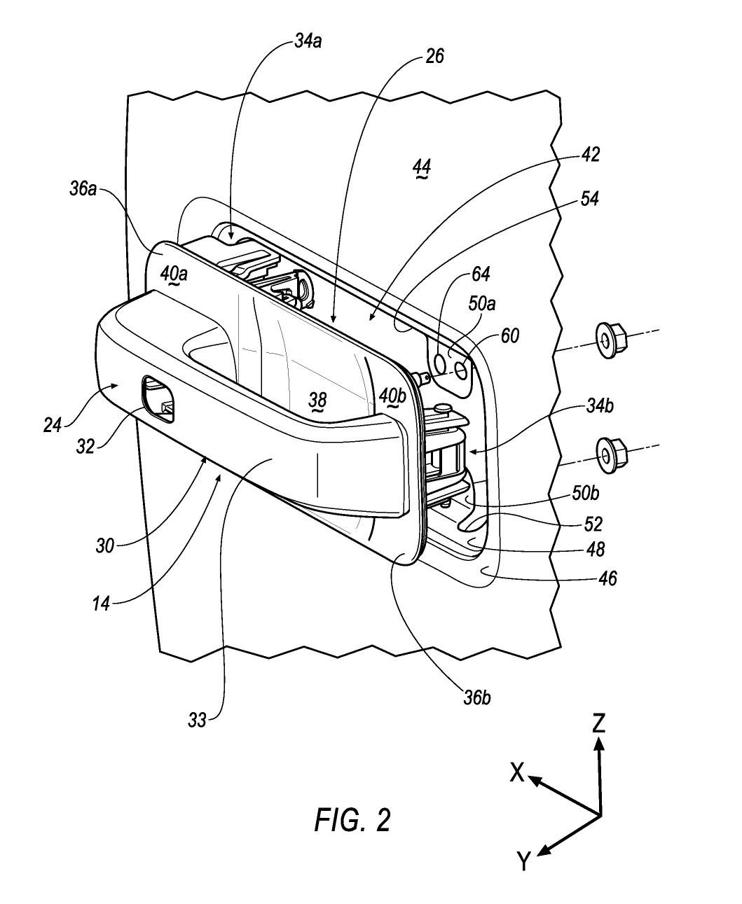

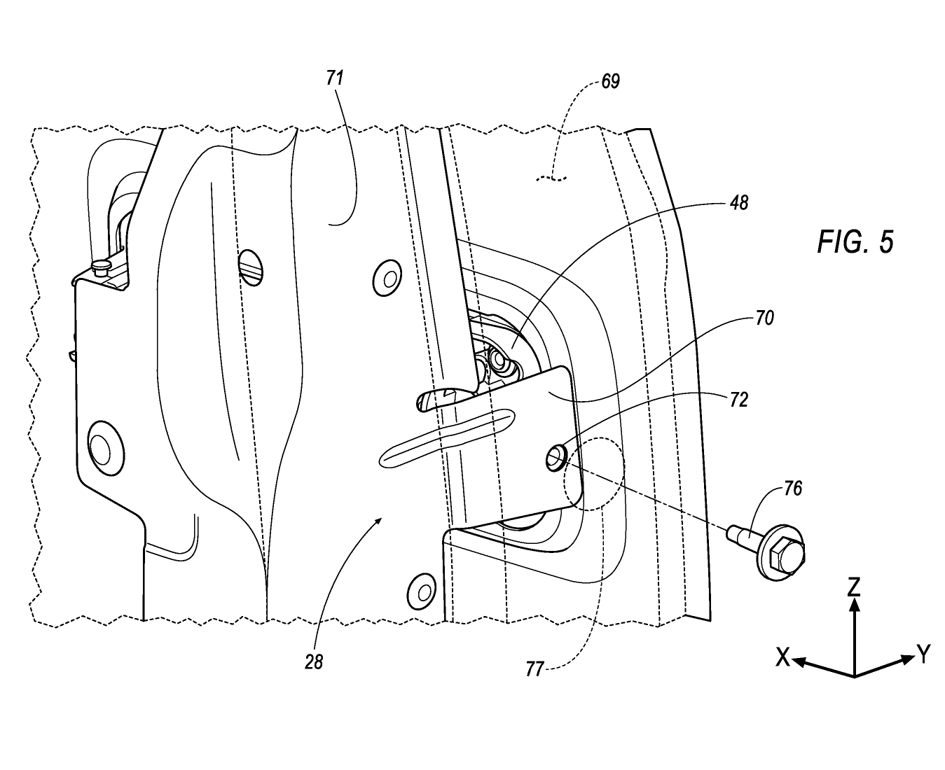

In one example, the door handle assembly 14 (best seen in FIGS. 2-6) comprises a handle subassembly 24, a bezel assembly 26, and an inner reinforcement member 28 (see FIG. 5). The handle subassembly 24 includes a handle member 30 that has a latch opening 32 for a latch release mechanism that is operatively connected to a latch mechanism (not shown). The handle member 30 includes a grip section 33 positioned between end members 34a, 34b that are received in openings formed in the bezel assembly 26. The latch opening 32 is positioned adjacent one of end members 34a. The handle subassembly 24 is fixedly connected to the bezel assembly 26.

The bezel assembly 26 includes first and second support sections 36a and 36b that are separated by an inwardly extending depression surface 38. The grip section 33 is positioned over the depression surface 38. The depression surface 38 serves to enable a handle to easily grasp around grip section 33 of handle member 30. First support section 36a and the second support section 36b may have exterior surface faces 40a, 40b that are substantially aligned along a common plane. In one example, the first support section 36a has a length (along the X axis) that is longer than a length of the second support section 36b.

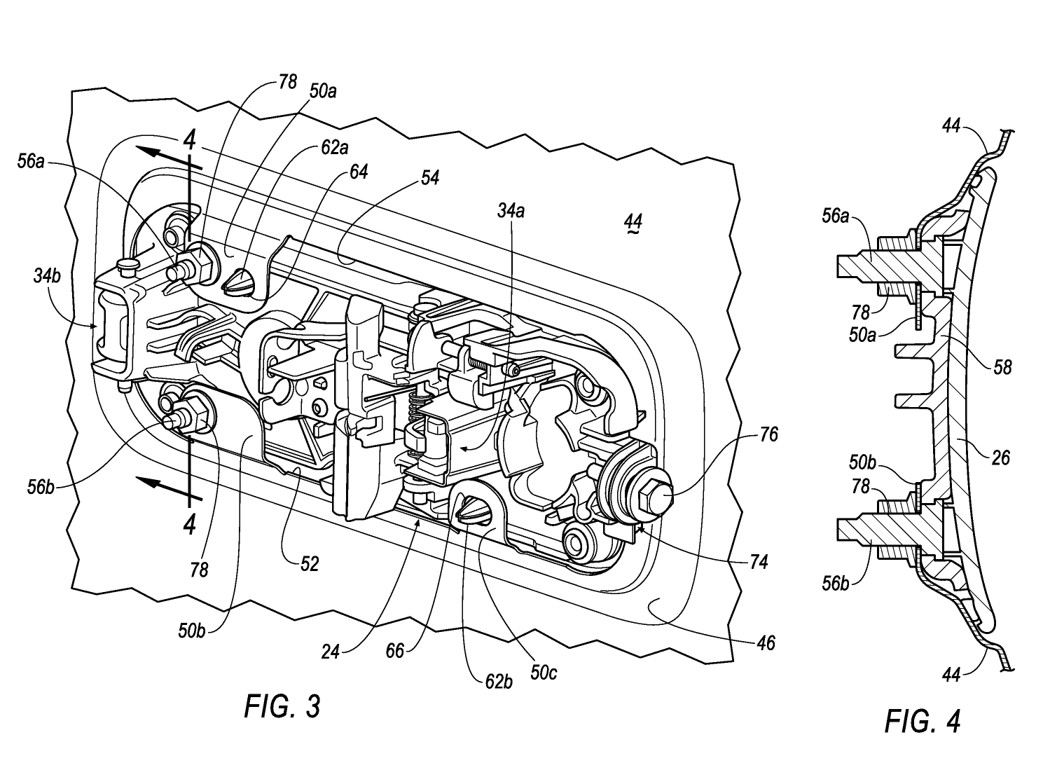

The bezel assembly 26 is configured to be received in a handle opening 42 formed through an outer door panel 44 that partially makes up door 10. In one example, outer door panel 44 is formed with an outline depression 46 about the handle opening 42. Depression 46 extends inwardly from an outer surface of the outer door panel 44 and is connected to an inwardly extending wall member 48. A pair of locating and attachment tabs 50a, 50b extend orthogonally from wall member 48. In one example, a first locating and attachment tab 50a is connected to a bottom edge 52 of wall member 48. A second locating and attachment tab 50b is connected to a top edge 54 of wall member 48 opposite of the first locating and attachment tab 50a. As shown in FIG. 3, a third locating tab 50c may be connected to the bottom edge 52. The locating and attachment tabs 50a-50c may be integrally formed with the outer door panel 44, such as in a stamping operation, for example. However, it is understood that locating and attachment tabs may be located at other positions along the handle opening 42. Locating and attachment tabs 50a, 50b serve to maintain the proper relationship of the connected together handle subassembly 24 and bezel assembly 26 with respect to the outer door panel 44.

Referring to FIGS. 3-4, the handle subassembly 24 further comprises at least two fastener elements 56a and 56b that extend through an inner plate member 58 of the handle subassembly 24, as well as through openings 60 formed through the locating and attachment tabs 50a, 50b (see FIG. 4). Additional locating members 62a, 62b may be provided to assist in properly positioning the handle subassembly 24 within the opening 42. In one example, locating member 62a is configured to be received within opening 64 of locating and attachment tab 50a. Locating member 62b is configured to be received within opening 66 of locating and attachment tab 50c. At least opening 66 may be oversized to permit minimal movement of the locating member 62b within the opening 66 to account for manufacturing tolerances.

Once fastener element 56a, 56b are positioned to extend through the openings 60 of the locating and attachment tabs 50a, 50b, a securing element 68a, 68b, such as a nut, secures the fastener element 56a, 56b directly to the outer door panel 44. With this configuration, the relationship between the handle assembly 14 and the outer door panel 44 is maintained.

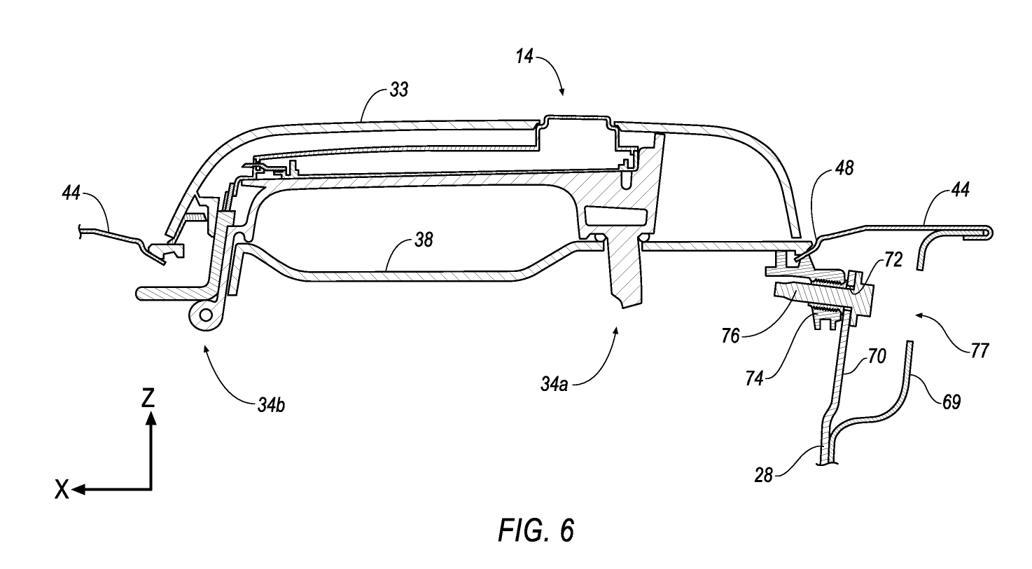

Turning to FIGS. 5-6, an inner reinforcement member 28 is partially illustrated. Inner reinforcement member 28 is positioned between an inner door panel (shown in phantom in FIG. 5) 69 and the outer door panel 44 and has a main body portion 71 that covers a portion of the handle subassembly 24 exposed through the opening 42 formed through the outer panel. The inner reinforcement member 28 includes a mounting flange 70 that extends generally perpendicular from the main body portion 71 and along a Y-Z plane of the vehicle door 10 such that the mounting flange 70 extends towards the outer door panel 44. A mounting opening 72 extends through the mounting flange 70.

The mounting opening 72 of the mounting flange 70 is configured to overlie an attachment member 74 formed in the door handle assembly 14 (see FIG. 3). The inwardly extending wall member 48 is positioned between the attachment member 74 and the outer door panel 44, as best seen in FIG. 6. A fastener 76 is directed through an opening 77 formed through the inner door panel 69 and through opening 72 of the mounting flange 70. The fastener 76 connects to the attachment member 74.

In the configuration described above, a tie point is created between the outer door panel 44 and the inner reinforcement member 28 in the YZ plane, such that the fastener 76 extends in an X direction, as opposed to a Y axis connection. With this configuration, any tolerances between in the Y direction between the bezel assembly 26 and the reinforcement member 28 will not result in surface distortion, as the connection is made in the X direction. During initial assembly, the fastener 76 may not be fully seated in the attachment member 74 such that the connection is loose fitting during initial assembly and painting operations.

However, during final securement of the door handle assembly 14 to the door 12, the bezel assembly 26 is positioned within the opening 42 formed in the outer door panel 44 and secured within the opening via fastener elements 56a, 56b that extend in the Y-axis through the openings 60 formed in the locating and attachment tabs 50a, 50b. The fastener elements 56a, 56b are introduced from a latch face side of the bezel assembly 26. A securing member 78, such as an attachment nut operates to secure the bezel assembly 26 directly to the outer door panel 44. However, because the attachment takes place while the bezel assembly 26 is sitting naturally on the outer surface of the outer door panel 44 due to the outline depression 46 into which the bezel assembly 26 fits, as demonstrated in FIG. 2, assembly induced surface defects are eliminated. The fastener 76 may then be fully seated in the attachment member 74 of the door handle assembly 14, through the opening 77 formed in the mounting flange 70. Because the connection is positioned in the X direction, any tolerances between the outer door panel and the inner reinforcement member is absorbed without resulting in any surface distortion.

The configuration of the present disclosure also allows all fastening operations to take place in direct view of the operator. For example, the fastener elements 56a, 56b are secured on inside of the outer door panel 44, in easy view of the operator. Further, the fastener 76 may be secured in the Y axis direction through opening 77 formed through an inner door panel 69. This same opening 77 also permits access to the fastener 76.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. An automotive door panel, comprising:
an outer panel defining a handle opening surrounded by an inwardly extending depression on an outside surface;
a bezel seated within the depression,
a handle mounted to the bezel and including an attachment member in a YZ plane; and
an inner reinforcement member having a mounting flange oriented in the YZ plane, wherein a fastener extends through the mounting flange in an X-direction to connect to the attachment member.

2. The automotive door panel of claim 1, further comprising an inwardly extending wall member extending from an edge of the handle opening.

3. The automotive door panel of claim 2, further comprising at least one locating and attachment tab extending from an outer edge of the inwardly extending wall member.

4. The automotive door panel of claim 3, wherein the locating and attachment tab includes at least one fastener opening that receives a fastener mounted to the bezel along a Y-direction.

5. The automotive door panel of claim 3, further comprising a plurality of locating and attachment tabs.

6. The automotive door panel of claim 5, wherein at least one of the locating and attachment tabs includes a fastener opening and a locating opening, wherein the fastener opening receives a fastener mounted to the bezel along a Y-direction and wherein the locating opening receives a locating element mounted to the bezel along the Y-direction.

7. The automotive door panel of claim 1, wherein a portion of the outer panel is positioned between the bezel and attachment member.

8. The automotive door panel of claim 1, wherein the inner reinforcement member is positioned between the outer panel and an inner panel.

9. The automotive door panel of claim 8, wherein the inner panel includes a clearance opening oriented in the YZ plane to provide access to the attachment member.

10. A door handle assembly for a vehicle, comprising:
a bezel assembly that receives a handle sub-assembly that comprises an attachment member oriented in a YZ plane with respect to the bezel assembly; and
an inner reinforcement member having a mounting flange oriented in the YZ plane, a fastener extending through the mounting flange in an X-direction and connecting to the attachment member;
wherein the attachment member and the bezel assembly are positioned on opposite sides of an outer door panel and the inner reinforcement member is spaced away from the outer panel so as not to contact the outer door panel.

11. The door handle assembly of claim 10, wherein the bezel assembly further comprises first and second support sections and that are separated by an inwardly extending depression surface.

12. The door handle assembly of claim 11, wherein the first and second support sections include exterior surface faces that are substantially aligned along a common plane.

13. The door handle assembly of claim 11, wherein the first support section has a length that is longer than a length of the second support section.

14. The door handle assembly of claim 10, wherein the attachment member further comprise an opening that is configured to receive the fastener.

15. The door handle assembly of claim 10, wherein the bezel assembly further comprises at least one fastener element that is configured to engage a portion of an outer door panel in a Y-direction to secure the bezel to the outer door panel.

16. The door handle assembly of claim 15, wherein the bezel assembly further comprises at least one locating member that is configured to be received within a portion of an outer door panel in the Y-direction to locate the bezel within the outer door panel.

17. An automotive door panel, comprising:
an outer panel defining a handle opening and having an inwardly extending depression formed on an outside surface surrounding the handle opening;
an inwardly extending wall member extending from an edge of the handle opening;
at least one locating and attachment tab extending from an outer edge of the inwardly extending wall member;
a bezel that seats within the depression and including at least one fastening element and one locating element that are configured to engage with the locating and attachment tab in a Y-direction,
a handle mounted to the bezel and including an attachment member in a YZ plane; and
an inner reinforcement member having a mounting flange oriented in the YZ plane, wherein a fastener extends through the mounting flange in an X-direction and connects to the attachment member.
